(19) United States
(12) Patent Application Publication
(10) Pub. No.: US 2006/0035742 A1
(43) Pub. Date: Feb. 16, 2006

(54) Reduction gear and drive unit using said reduction gear

(76) Inventors: Cornelius Peter, Buehl-Neusatz (DE); Angelika Peter, Buehl-Neusatz (DE)

Correspondence Address: ST. ONGE STEWARD JOHNSTON & REENS, LLC, 986 BEDFORD STREET, STAMFORD, CT, 06905-5619, US

(21) Appl. No.: 11/201,934

(22) Filed: Aug. 11, 2005

(30) Foreign Application Priority Data
Aug. 11, 2004 (DE) 10 2004 039 057.6

(51) Int. Cl. F16H 23/00; F16H 35/00

(52) U.S. Cl. 475/163; 74/640

(57) ABSTRACT

The present invention refers to a reduction gear and to a drive unit in which a reduction gear of this type is used. A distinctive feature of the drive unit is a particularly flat design, since the individual components are assembled around a fixed bearing rod and intermesh. The reduction gear has a drive element which executes a wobbling motion within a driven element which covers the drive element.

This application claims priority of German Patent Application No. 10 2004 039 057.6 filed on Aug. 11, 2004.

### FIELD OF THE INVENTION

This invention refers to a reduction gear and in particular to a drive unit in which a reduction gear of this type is used.

Reduction gears serve to convert a high input speed such as that typically produced by electric motors to a low output speed, to enable movement of certain bodies via appropriate mechanisms. Reduction gears of more compact design are increasingly being used in sectors of automotive engineering where they form components of actuating motors such as those used in window-opening motors, seat-adjustment motors, etc.

A wide variety of gearing mechanisms for reduction gears is known in the professional world. One special form of such reduction gears are those generally known as “harmonic drive mechanisms.”

The general function of these mechanisms is based on the fact that a rotary driven core radially deforms a radially deformable inner wheel rim element in a revolving action, thereby locally pressing the exterior lateral surface of the element outwards against a hollow-cylindrical interior lateral surface of a stationary and dimensionally stable support ring fixed to a housing and having a slightly larger circumference. As a result—depending on the particular type—the inner wheel itself or a wheel rim rotatably mounted on the wheel rolls off non-positively over friction surfaces or positively over teeth in the support ring, with the wheel or its rim rotating more slowly than the core driven by the electric motor, as dictated by the circumferential difference or by the number of teeth between the support ring and the inner wheel. This rotary movement is thereby slowed substantially relative to the drive, and it can be transferred, preferably via external gear teeth of the inner wheel rim, to internal gear teeth of an additional outer ring, which is concentric to the support ring but contrary to it is not stationary, but rather coaxially rotatable. The outer ring is equipped with an output shaft rotatably mounted in the gearbox housing.

A reduction gear of this state-of-the-art type is known from the German Utility Model DE 29614738 U1, in which the radial deformability of an inside drive element is exploited. A radially flexible gear wheel braces itself by its outer lateral surface at least in sections against a cylindrical support surface surrounding the lateral surface, from which it rolls off accordingly. Driven by an eccentric, particularly elliptical driving core, at least one continually changing peripheral segment of the outer lateral surface of the drive element is kept in non-slip engagement with the support surface of a rigid support ring. At the same time a driven element disposed above this and provided as an internal gear is kept in engagement with the drive element. Through the rotary movement of the eccentric or elliptical driving core the drive element is continuously elliptically deformed. This elliptical deformation is transmitted due to the fact that teeth of the outer gearing of the drive element continuously enter into engagement with the inner teeth of the stationary support ring. Through selection of a smaller number of teeth for the outer gearing of the drive element than for the inner teeth of the support ring, a continuous rotation of the drive element relative to the stationary support ring is produced. This rotation is then transferred with a corresponding reduction to the driven internal gear disposed above the drive element.

An additional state-of-the-art gearbox is known from the German laying-open specification DE 19708310 A1, which takes up the principle of a deformable drive element. In one embodiment of the reduction gear known from this publication, a plurality of inside drive elements is used. For example, instead on one single radially deformable inner gear, two or three planet gears are to be used. These planet gears, turning on a radially deformable ring with teeth on its outer lateral surface, roll off from the inner side of the ring, so that two or three peripheral segments of this outer lateral surface always mate with the inner teeth of a support ring.

A further state-of-the-art reduction gear is known from the German patent specification DE 19943021 C1. In this reduction gear the principle described above is likewise implemented. The driven element therein is provided as an internal gear which covers the drive element in a bowl-like manner and is provided on its surface with a centric output shaft extending coaxially to the input shaft of the motor. The “bowl-like” structure shown in this publication permits a particularly flat construction of the total drive unit, which makes it is especially suitable for use in close quarters.

All of the above-given reduction gears have in common the disadvantage that at least one radially flexible or radially deformable drive element must be provided. This aspect already has to be taken into account in the manufacture and design of the reduction gear and in the selection of material for the drive element, and that increases the costs. Moreover, depending on the particular embodiment, it is sometimes difficult to assemble the parts of the reduction gears described above. The elastically deformable drive element in particular has to be inserted simultaneously into the internal gearing of the outer support ring and of the rotatable driven element.

In addition, a reduction gear with a drive element and a driven element is known from U.S. Pat. No. 4,112,788. The driven element therein is provided in the form of an internal gear and the drive element is eccentrically mounted relative to the axis of rotation of the driven element, such that at least one peripheral segment of the lateral surface of the drive element is in continually changing contact with the inner surface of the internal gear. A distinctive negative feature of this reduction gear is its relatively tall structure.

Taking this as a basis, it is the object of the present invention to provide a reduction gear that obviates the principle of radially deformable elements, but nonetheless ensures adequate reduction while providing a simple assembly and a flat structure. A further object of the present invention is to provide a drive unit which utilizes a reduction gear of this type and the advantages associated with it.

These objects are accomplished respectively with a reduction gear having the features given in claim 1 and with a drive unit having the features given in claim 13.

Accordingly, the core of the invention consists in the fact that the reduction gear comprises an internal gear as the driven element and a drive element arranged within this internal gear and cooperating with it, such that both the drive element and the driven element are mounted together on a fixed and non-rotational bearing rod. In other words, the shaft about which all reduction gear components together are built up at least partly in rotational symmetry, is stationary. This bearing rod preferably forms a component of the housing of the reduction gear or of the drive unit containing the same.

The embodiment of the reduction gear according to the invention permits a simple assembly of all its components on the bearing rod fixed to the housing, with the individual components merely having to be set one upon the other onto the bearing rod. On the whole a central fixed shaft simplifies the bearing mount of the rotating components.

In accordance with the invention, the drive element is eccentrically mounted relative to the axis of rotation of the driven element, which coaxially coincides with the axis of the fixed and non-rotational bearing rod.

In this manner it becomes possible, if the drive element has a smaller circumference than the driven element, for at least one peripheral segment of the lateral surface of the drive element to be in continually changing contact with the inner surface of the driven element, which is provided in the form of an internal gear. It is to be noted that, contrary to the prior art described above, the drive element, which is disposed on the inside, is not radially deformable, but rather it is rigid.

To enable a corresponding, reduced transmission of the high rotational speed originating from a motor, in accordance with the solution proposed by the invention a rotational movement of the inside drive element about the axis of the bearing rod has to be prevented. For this purpose, according to the invention at least one fixed bearing is provided, in which the drive element is mounted with play.

This play in this bearing mount is selected in accordance with the invention to permit the drive element to perform a so-called wobbling motion about the axis of the stationary bearing rod when it rolls off from the at least one peripheral segment of the lateral surface of the drive element.

The circumferential difference of the drive element from the outer gear on the one hand, and the eccentric bearing mount of the drive element on the other have the effect that every point of the drive element outside of the central axis of the stationary bearing rod executes a near-circular motion.

To make this possible, the drive element has a hub in which a motor-driven eccenter, in effect the drive core, is glidingly accommodated. The eccenter itself is mounted for rotation about the axis of the stationary bearing rod. The eccentricity is transferred to the drive element by the rotation of the eccenter about the bearing rod, with the outer lateral surface of the eccenter being glidingly displaced relative to the inner surface of the hub of the drive element.

This is true since the drive element is prevented from rotating in the at least one fixed bearing. Thus, the degree of freedom provided in accordance with the invention by the play in the bearing mount is merely a corresponding wobbling motion of the drive element in the horizontal plane.

In a special embodiment of the reduction gear according to the invention, the drive element is non-rotatably arranged on a bearing plate lying opposite the internal gear. The bearing plate is mounted for horizontal movement and has an opening for no-contact passage of the bearing rod during the entire wobbling motion. The horizontally movable mounting of the bearing plate is of course such that the play of the mounting likewise permits only a horizontal movement of the drive element or the bearing plate of a sort that allows a continuous peripheral segment-by-segment roll-off of the drive element in the internal gear.

For reasons of production engineering it is advantageous for the drive element to be integral with the bearing plate, and preferably to be provided as an injection-molded plastic part.

The horizontally movable bearing mount of the bearing plate or of the drive element disposed thereupon is achieved in a particular embodiment of the reduction gear according to the invention, in that the bearing plate has four journals at each of its mutually opposite corners, which extend vertically away from the drive element and parallel to the axis of the stationary bearing rod, and which are accommodated in fixed bearing sleeves provided at corresponding locations, with the bearing mount in each case being equipped with the play necessary for the horizontal circular motion.

To reduce excessive noise development during the wobbling motion of the drive element or of the particular journals in the bearing sleeves, noise-reducing damping elements are provided between these two elements, either on the bearing sleeve or on the journal.

The wobbling motion executed by the drive element is then transferred to the driven element, which is provided in the form of an internal gear. The driven element is rotatably mounted on the stationary bearing rod and, accordingly, can execute only a rotating movement.

The driven element has on its side opposite the drive element an output part such as a pinion or a friction wheel, which then cooperates with a corresponding transmission element such as a chain or a belt of the mechanism to be driven by the reduction gear. In an advantageous embodiment the driven part and the driven element are formed in one piece, particularly as an injection-molded plastic part. The internal gear on the output side can cover the drive element in a bowl-like manner.

In a further embodiment of the reduction gear according to the invention the particular fixed components, the bearing sleeves and the bearing rod, are arranged on a common carrier plate of a housing and in particular are integrally connected to the same, especially in the form of an injection-molded plastic part.

The structure of the reduction gear as described above can be implemented through a non-positive connection or a positive connection.

Accordingly, in one embodiment the drive element is provided as a friction wheel and the driven element as a rim, with the continually changing peripheral segment of the outer lateral surface of the friction wheel rolling off on the inner lateral surface of the rim. Depending on the circumferential difference, a corresponding reduction can be transmitted from the rotation of the motor-driven eccenter to the output-side internal gear which is rotatably mounted on the bearing rod axis fixed to the housing.

In a further embodiment the drive element is provided as a gear wheel and the driven element as an internal gear with inner teeth. A peripheral segment of the gear wheel meshes with the teeth of the internal gear. Correspondingly, the desired reduction is achieved in this embodiment through a specified difference in the number of teeth between the inner teeth of the internal gear and the outer teeth of the gear wheel.

A distinctive feature of the structure of the reduction gear according to the invention is that an extremely flat structure can be achieved. Moreover, the number of components is reduced in comparison to the solutions known from the prior art. This minimizes costs and permits inexpensive manufacture using the technique of plastic injection molding. The arrangement of all components on a shaft that is fixed to the housing and/or stationary additionally enables a very simple assembly of all components.

With a reduction gear of this nature transmission ratios ranging from 15:1 to 100:1 can be achieved, depending on the selection of the circumferential differences or differences in number of teeth. The kinematics on which the reduction gear is based, that of merely a horizontal wobbling motion of the drive element, further permits the use of relatively “coarse” teeth for the gearing, so that the production costs can be further reduced.

Concerning another aspect of the invention, the use of the reduction gear described above is provided in combination with a drive unit which likewise incorporates the advantages realized by the invention in the reduction gear.

The drive unit according to the invention, in conjunction with the reduction gear of the invention, additionally has an electric motor comprised of a rotor and a stator.

According to the invention the rotor is also arranged on the fixed and non-rotatable bearing rod. This type of bearing mount makes a simple assembly possible for such a drive unit as well, while an extremely simple structure is also achieved.

In one embodiment of the drive unit according to the invention the rotor is designed as an external rotor and covers the stator in a bowl-like manner. This makes it possible for the stator to be non-rotatably arranged on the carrier plate, namely around the bearing rod. This further increases the compactness of design.

The eccenter for the reduction gear, cooperating with the rotor, can be provided either as a separate component rotatably mounted on the stationary bearing rod, or it can be non-rotatably connected to the surface of the bowl-like rotor, preferably integrally with it, particularly in the form of an injection-molded plastic part.

The carrier plate with the fixed bearing rod and bearing sleeves can furthermore accommodate the electronic control unit and if applicable a sensor device for the electric motor.

It becomes clear that through the arrangement of all components of both the reduction gear and the electric motor on one common carrier plate a drive unit is created which can be offered as a complete module and which can be installed in places offering little space.

In the drive unit the use of a brushless motor that works with low noise and permits control via the rotational speed or via regulation of the current is especially well suited. This is particularly advantageous in the use of the drive unit of the invention as a window-opening motor, for example, since with the imminent hazard of getting fingers caught a rapid reverse must be guaranteed. This can be accomplished more quickly and easily from a technical standpoint in a brushless motor.

To enable such a corresponding control or regulation in the drive unit, the rotor of the electric motor in one embodiment of the drive unit of the invention has a ring arranged in the interior of the bowl-like rotor. This ring extends vertically beyond the outer lateral surface of the rotor towards the carrier plate. This results in a ring that is clear of the bowl of the exterior rotor.

According to the invention, the sensor device for this can be composed of Hall sensors that are arranged on the carrier plate in such a manner that they lie opposite the exposed ring and that at corresponding peripheral segments of the ring they conduct a rotational speed measurement through the occurrence of the known Hall effects.

The drive unit according to the invention is particularly well-suited for use in the field of motor vehicles, where the constructional spaces are generally limited. For instance the drive unit can be used as a variable displacement motor in general for adjusting the vehicle seats, as a window-opening motor or as a motor for the windshield wipers.

Of course fields of use outside that of motor vehicles are just as feasible, wherever there is always only a limited amount of available space and in which an appropriate gear reduction must be provided.

### BRIEF DESCRIPTION OF DRAWINGS

The present invention will now be described in greater detail on the basis of the embodiments represented in the accompanying drawings, which show in:

FIG. 1 a schematic cross-sectional view of the reduction gear according to the invention;

FIGS. 2a, 2b, 2c, 2d viewed from below, schematic cross-sectional views of four different positions of the drive element within the driven element of the reduction gear according to the invention;

FIG. 3 a schematic cross-sectional view through the drive unit according to the invention, comprising the reduction gear of the invention and an electric motor;

FIG. 4 an exploded view of the drive unit;

FIG. 5 a perspective view of the drive unit with the driven unit removed;

FIG. 6 a perspective view of the drive unit with the driven element mounted; and

FIG. 7 a lateral view of the electric motor with the control unit.

### DETAILED DESCRIPTION OF DRAWINGS

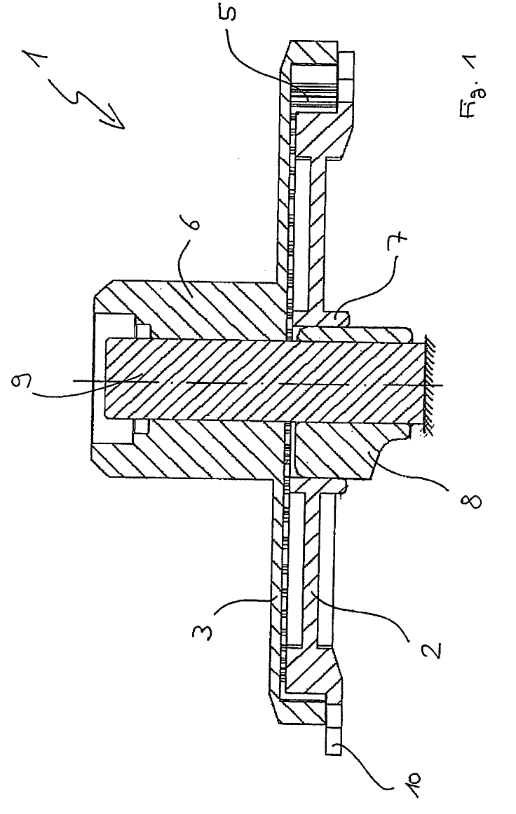

FIG. 1 shows a schematic view of a cross section through a reduction gear 1 according to the present invention.

The reduction gear 1 substantially comprises a drive element 2 and a driven element 3.

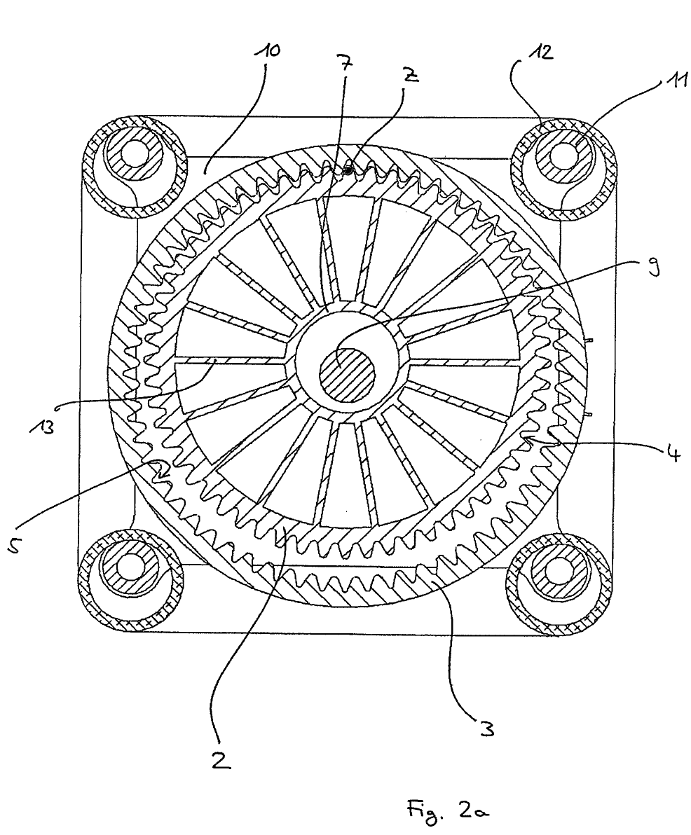

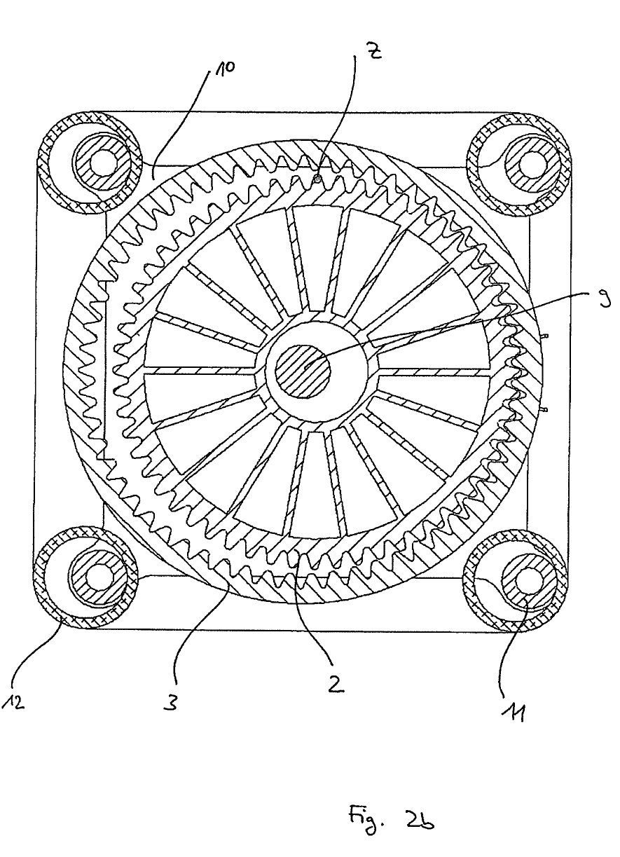

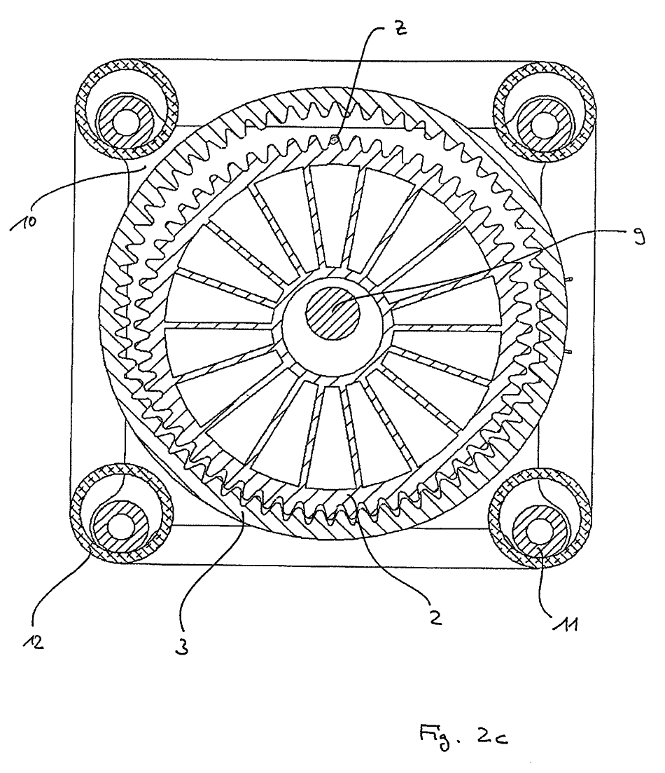

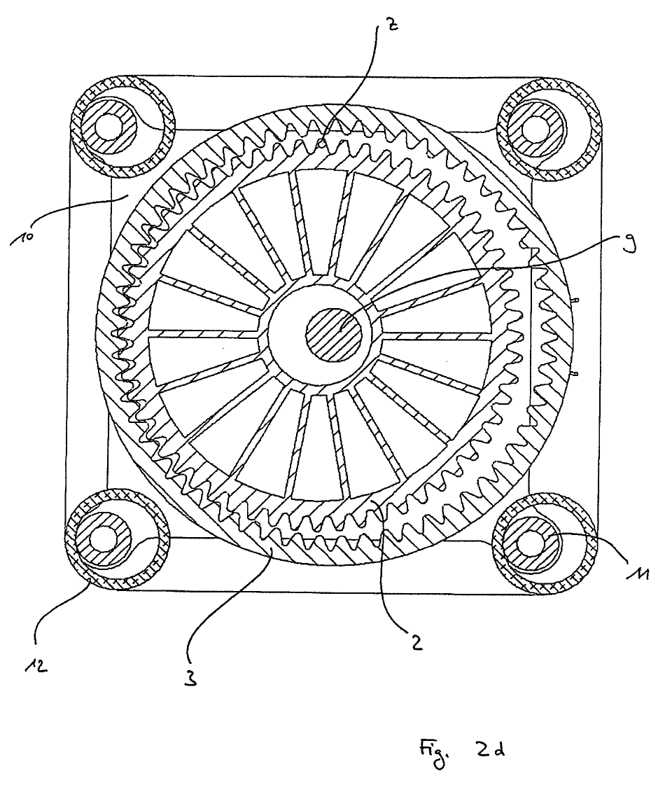

The drive element 2 is designed as a rigid, non-deformable gear wheel with outer teeth 4. The outer teeth 4 of the gear wheel 2 mesh over a peripheral segment with inner teeth 5 of the driven element 3, as seen in particular in FIGS. 2a to 2d.

The driven element 3 is designed accordingly as an internal gear which covers the gear wheel 4 in a bowl-like manner. The internal gear 3 has a driven element 6 integrally formed on the side opposite the gear wheel 2. Said driven element 6 is to cooperate with a transmission element of the mechanism to be driven by the reduction gear 1; the transmission element is not shown in detail here. In the present illustration the driven part 6 is provided as a friction wheel which, for example, can cooperate with a belt.

The gear wheel 2 has a hub 7 which receives a motor-driven eccenter 8. The eccenter 8 is accommodated to glide in the hub 7, i.e. it can turn relative to the inner peripheral surface of the hub 7.

As seen in FIG. 1, all elements of the reduction gear 1, the gear wheel 2, the internal gear 3 and the motor-driven eccenter 8 are arranged for rotation about a common bearing rod 9.

The bearing rod 9 itself however, is fixed, i.e. non-rotating, for instance in a housing provided for the reduction gear 1 but not shown in detail here.

With the aid of sectional views through the reduction gear 1 of the invention, viewed from below, FIGS. 2a to 2d will now demonstrate the movement executed by the gear wheel 2. To provide a better illustration, the cross-hatching of the eccenter 8 has been omitted.

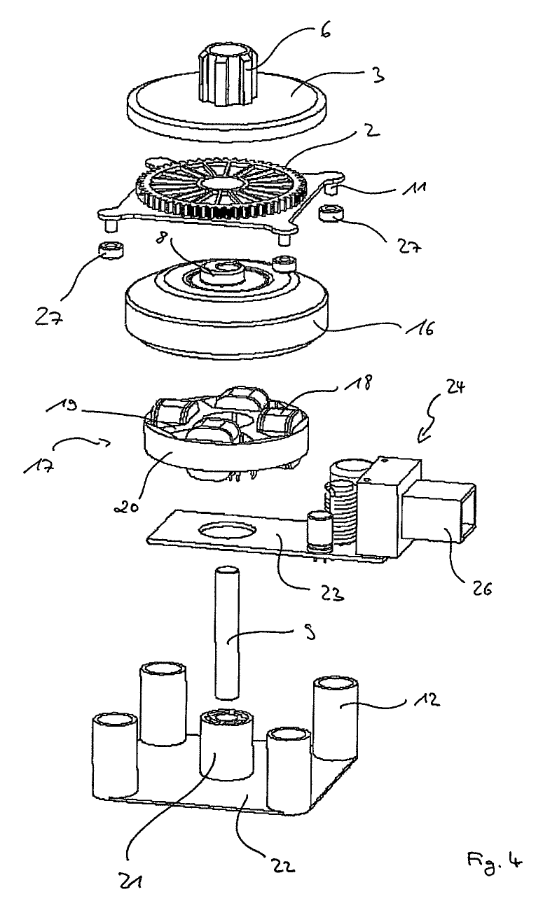

The gear wheel 2 is provided integrally on a bearing plate 10. The bearing plate 10 has journals 11 on each of its corners. The journals 1 1 are mounted in bearing sleeves 12 fixed to the housing, as shown by way of an example in FIGS. 4 to 6.

Due to the bearing mount thus provided for the gear wheel 2 in four bearing sleeves 12 arranged concentrically around the bearing rod 9, rotary motion of the gear wheel 2 is completely prevented. The journals 11 of the bearing plate 10 themselves are mounted in the bearing sleeves 12 with an appropriate play. This play corresponds exactly to the wobbling motion in the horizontal plane which is executed by the gear wheel 2 upon transmission to the driven internal gear 3.

It can be seen that the gear wheel 2 has spokes 13 between its hub 7 and its outer teeth 4, to permit a certain weight reduction but keep sufficient rigidity.

On the basis of Point Z on one of the outer teeth 4 of the gear wheel 2, the wobbling motion of the gear wheel 2 is to be illustrated as an example in the sequence of FIGS. 2a to 2d.

FIG. 2a shows a first position of the gear wheel 2. The eccenter 8 rotates in the hub 7 and its eccentricity points to the top in FIG. 2a, so that the tooth Z, within its corresponding peripheral segment of the outer teeth 4 of the gear wheel 2, engages with the inner teeth 5 of the internal gear 3. The journals 11 correspondingly abut the upper sections of the bearing sleeves 12.

As FIG. 2b shows, the eccenter 8, gliding within the hub 7 of the gear wheel 2, has now turned farther clockwise by another 90 degrees in the illustration. The effect of this is that the tooth Z in its particular position no longer engages the rotatably mounted driven internal gear 3. Instead, the peripheral segment of the gear wheel 2 that is meshing with the inner teeth 5 likewise moves on clockwise by 90 degrees. This movement is also executed by the journals 11 in the bearing sleeves 12.

FIG. 2c shows a further clockwise turn of the eccenter 8 by 90 degrees. The peripheral segment meshing with the inner teeth 5 of the internal gear 3 moves on correspondingly by 90 degrees clockwise. This movement is continued, as seen in FIG. 2d, until ultimately the tooth Z comes once more to mesh with the inner teeth 5 of the internal gear 3.

From this sequence of movements it will be recognized that the point or the tooth Z does not revolve around the axis of the bearing rod 9, but rather is performs a near-circular motion outside of the center defined by the axis of the bearing rod 9. This describes the wobbling motion of the gear wheel 2 and/or of the bearing plate 10. The journals 11 describe this near-circular movement in the bearing sleeves 12 in the same manner.

It becomes clear that due to the fact that the gear wheel 2 does not revolve around the axis of the bearing rod 9 but merely wobbles horizontally, and that therefore a continuously changing peripheral segment of its outer teeth 4 rolls off segment by segment from the inner teeth 5, the wobbling motion is converted to a rotation of the rotatably mounted internal gear 3. Through the differences in the number of teeth, wherein the number of teeth of the gear wheel 2 is suitably less than the number of teeth of inner teeth 5 of the internal gear 3, corresponding transmission ratios can be realized.

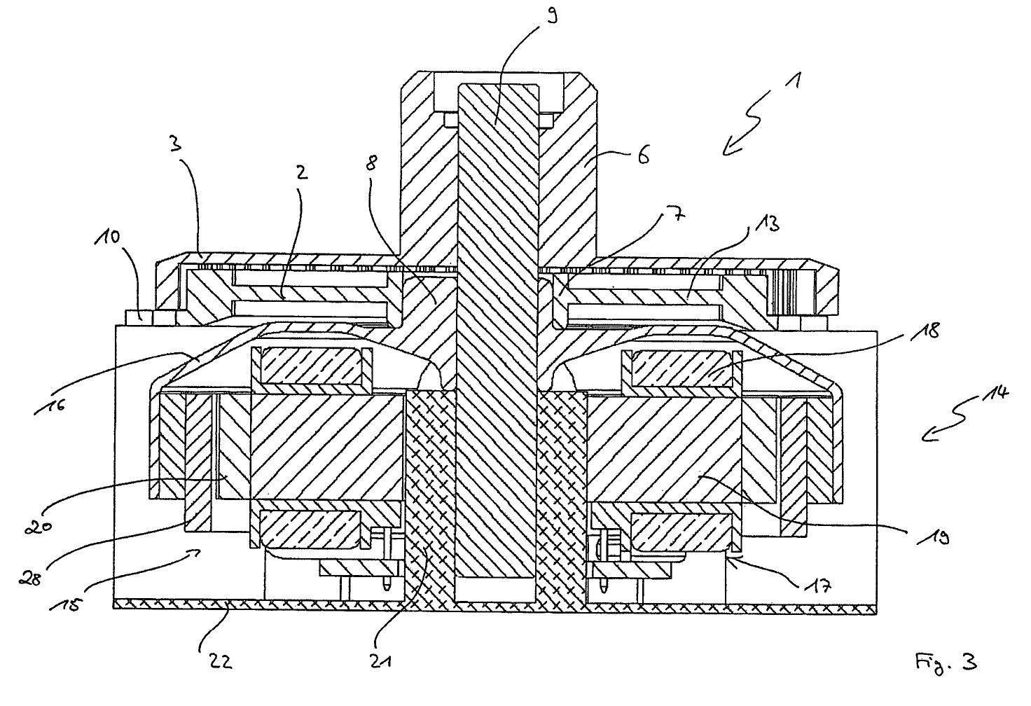

FIG. 3 shows as an example a cross section through a drive unit 14 according to the invention, which has the reduction gear 1 in combination with an electric motor 15.

The electric motor 15 comprises a rotor 16 and a stator 17.

The rotor 16 is an external rotor and covers the stator 17 in a bowl-like manner. The stator 17 has four mutually opposite coils 18. The coils 18, as shown in FIG. 4, are set on a star-shaped stator core 19 and are surrounded by a peripherally closed stator ring 20. This permits simple installation of the coils 18. Therefore, separately winding the stator cores 19 becomes unnecessary, and within the drive unit 14 simple installation of the entire stator 17 on the bearing rod 9 is made possible.

As seen in FIG. 3, the eccenter 8 is integral with the bowl-like rotor 16. Since the eccenter 8 engages directly in the hub 7 of the gear wheel 2, a very compact structure is thereby created.

The bearing rod 9 is non-rotatably accommodated in a bearing bush 21. The stator 17 of the electric motor 15 is non-rotatably arranged around the bearing bush 21.

The bearing bush 21 for the bearing rod 9 is part of a carrier plate 22 and is integrally formed with it.

As the exploded view in FIG. 4 shows, the carrier plate 22 further supports the four bearing sleeves 12 of the reduction gear 1, in which the journals 11 are accommodated with play.

In addition, a board 23 can be arranged on the carrier plate 22 through an attachment to the bearing bush 21. The electronic control unit 24 and a sensor device 25, as well as a power supply 26 for the electric motor 15 are arranged on the board. It becomes clear that this further increases the compactness and the possibility of a flat structure of the entire drive unit 14.

As shown in FIG. 4, the journals 11 of the bearing plate 10 of the gear wheel 2 are guided in the bearing sleeves 12 with damping elements 27 to achieve a suitable noise reduction.

In the embodiment shown in FIG. 4 the output part 6 of the driven element 3 is provided as a pinion, for instance for a V-belt.

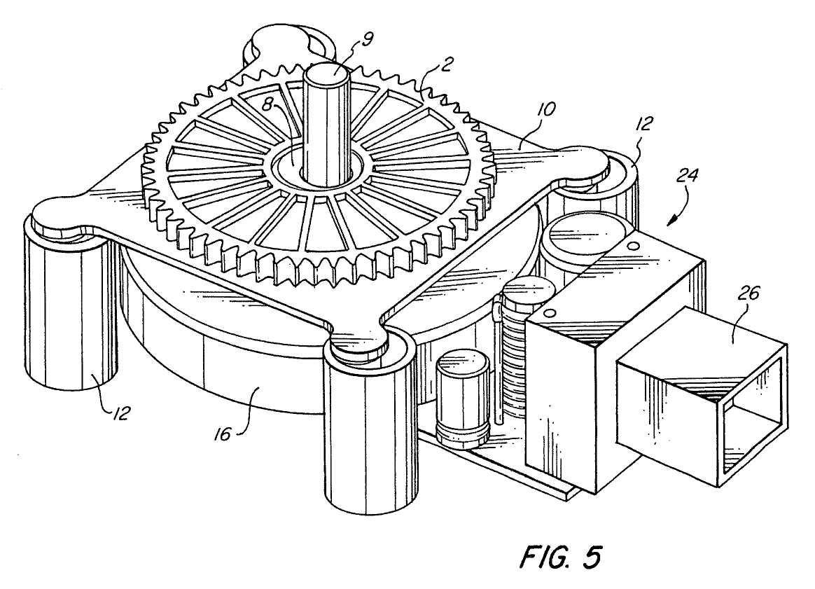

FIG. 5 shows as an example a perspective view of the drive unit 14 with the driven element 3 removed. It will be recognized that the bearing plate 10 is mounted in the four bearing sleeves 12 for horizontal movement via the journals 11. The eccenter 8, which rotates about the bearing rod 9, runs in the hub 7 of the gear wheel 2, with the outer lateral surface of the eccenter 8 gliding or turning relative to the inner surface of the hub 7, thus effecting the horizontal displacement of the bearing plate 10 or of the gear wheel 2 during the wobbling motion.

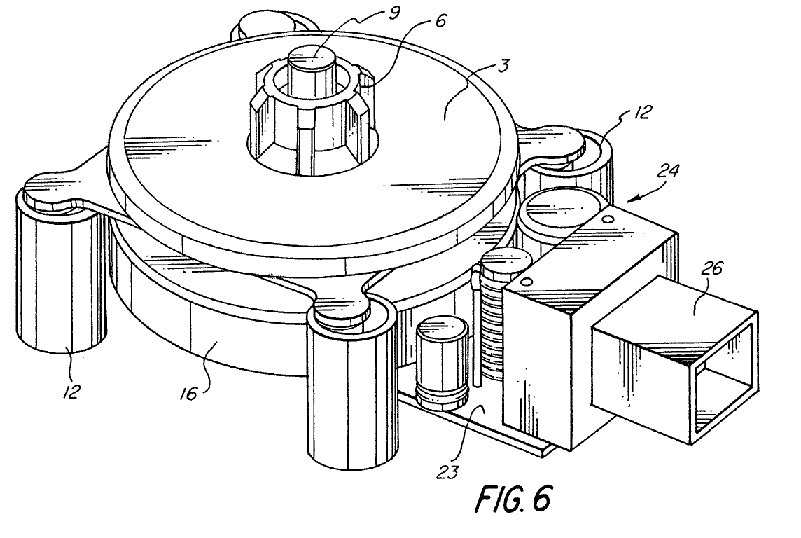

FIG. 6 shows a perspective view of the complete drive unit 14 with the driven element 3 rotatably mounted on the bearing rod 9. It will be recognized that a distinctive feature of the drive unit 14 is a particularly flat design in which all components of the reduction gear 1, of the electric motor 15 and the corresponding additional components 24, 25, 26 can be provided in one module.

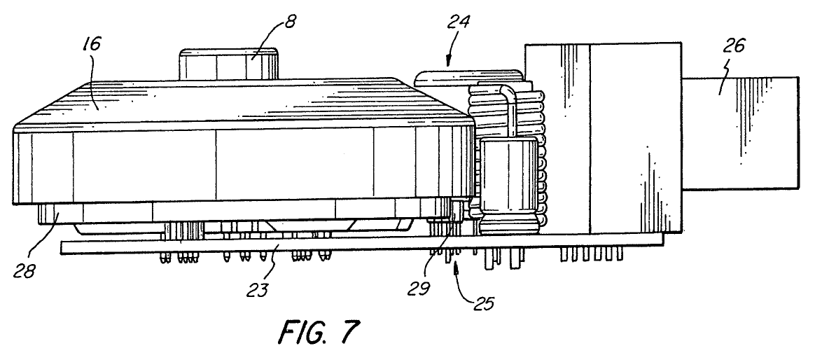

As seen in the sectional illustration of FIG. 3 and in the lateral view of FIG. 7, the rotor 16 additionally has a revolving ring 28 extending vertically downwards, beyond the outer lateral surface of the rotor 16 and concentrically to the bearing rod 9. This revolving ring 28 cooperates with the Hall sensors 29, which are arranged on the board 23 at positions where they can scan the revolving ring 28.

1. A reduction gear comprising a drive element and a driven element, with the driven element being provided in the form of an internal gear, and with the drive element being eccentrically mounted relative to the axis of rotation of the driven element, such that at least one continually changing peripheral segment of the lateral surface of the drive element contacts the inner surface of the internal gear, characterized in that the drive element and the driven element are mounted on a fixed and non-rotating bearing rod.

2. The reduction gear according to claim 1, wherein the drive element is mounted in at least one fixed bearing, such that a rotational movement of the drive element about the axis of the bearing rod is prevented, with the bearing mount of the drive element having in said at least one fixed bearing at least sufficient play for the drive element to execute a wobbling motion about the axis of the bearing rod when its at least one peripheral segment of its lateral surface rolls off from the inner surface of the internal gear.

3. The reduction gear according to claim 2, wherein the drive element has a hub accommodating a motor-driven eccenter rotatably mounted around the axis of the bearing rod.

4. The reduction gear according to claim 3, wherein the drive element is non-rotatably arranged on a bearing plate lying opposite the internal gear, said bearing plate being mounted for horizontal movement and having an opening for no-contact passage of the bearing rod.

5. The reduction gear according to claim 4, wherein the bearing plate has four vertical journals on the side opposite the drive element and parallel to the bearing rod, said journals being guided with play in four fixed bearing sleeves in concentric arrangement around the bearing rod.

6. The reduction gear according to claim 5, wherein damping elements are provided between the journals and the bearing sleeves.

7. The reduction gear according to claim 4, wherein the drive element is formed integrally, particularly as an injection-molded plastic part, with the bearing plate.

8. The reduction gear according to claim 1, wherein the internal gear is rotatably mounted on the bearing rod and has an output part on its side opposite the drive element, with said output part cooperating with a transmission element of the mechanism to be driven by the reduction gear.

9. The reduction gear according to claim 8, wherein the output part and the driven element are formed integrally, particularly as an injection-molded plastic part.

10. The reduction gear according to claim 5, wherein the bearing sleeves and the bearing rod are arranged on a common carrier plate and in particular are formed integrally with the carrier plate, particularly as an injection-molded plastic part.

11. The reduction gear according to claim 1, wherein the drive element is provided as a friction wheel and the driven element as a rim, thereby forming a non-positive contact.

12. The reduction gear according to claim 1, wherein the drive element is provided as a gear wheel and the driven element as an internal gear with inner teeth, thereby forming a positive contact.

13. A drive unit comprising an electric motor with a rotor and a stator, and further comprising a reduction gear according to claim 1, characterized in that the rotor, the eccenter and the driven element are rotatably arranged on the fixed and non-rotatable bearing rod.

14. The drive unit according to claim 13, wherein the eccenter is formed integrally with the rotor, particularly as an injection-molded plastic part.

15. The drive unit according to claim 13, wherein the stator is non-rotatably disposed on the carrier plate around the bearing rod and the rotor is provided as an internal gear lying externally over the stator.

16. The drive unit according to claim 13, wherein the carrier plate has an electronic control unit and a sensor device for the electric motor.

17. The drive unit according to claim 17, wherein the rotor has a ring lying in the interior, said ring extending vertically beyond the outer lateral surface of the rotor towards the carrier plate.

18. The drive unit according to claim 17, wherein the sensor device is composed of Hall sensors arranged on the carrier plate in such a manner that they lie opposite the exposed peripheral section of the ring.

19. The use of a drive unit according to claim 13 as a variable displacement motor in a motor vehicle.
